(19) United States
(12) Patent Application Publication
(10) Pub. No.: US 2003/0105806 A1
(43) Pub. Date: Jun. 5, 2003

(54) Service facilitator for automating object conversions and communication connections in client-server systems

(76) Inventors: David G. Gayle, Golden, CO (US); Nicole A. Nemer, Superior, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/004,576

(22) Filed: Dec. 4, 2001

(51) Int. Cl. G06F 15/16

(52) U.S. Cl. 709/203; 709/217; 709/246

(57) ABSTRACT

A system for automating communications between clients and service providers. The system includes a service provider providing a target service and including a conversion and connection mechanism for receiving streamed service requests, converting the service requests into request documents, and transmitting the request documents to the target service. A tool is included for converting the request document into a service request object expected as input by the target service. The system includes a client device with a client that functions to create a service request object, which is converted by a request generator into a request document. A conversion and connection mechanism receives the request document and identifies the target service and service provider server servicing the target service. The mechanism opens a connection with the service provider server and converts the request document into a string, applies protocols, and transmits the string to the service provider.

### BACKGROUND OF THE INVENTION

1. Field of the Invention

The present invention relates, in general, to data transfer and establishing communication links and connections in computer networks, and, more particularly, to a system and method for facilitating development of services in a client-server system including automated object to streaming document (such as a markup language document) conversion and automated communication connection establishment.

2. Relevant Background

It is becoming increasingly common to provide services remotely throughout distributed computer networks based on a client-server model. Numerous services may be provided in this manner including credit card services, online shopping services, travel services, tax services, and many other services suitable for online offerings. Typically, one or more service provider will operate a server with an offered service and client devices, such as other servers, personal computers, and other electronic communication devices, request these services from the service provider via a data communications network, such as the Internet, a local area network (LAN), wide area network (WAN), and the like. The client submits a request over the communications network and relatively quickly receives a response providing the requested service, such as a credit card authorization.

While appearing simple on the surface, the implementation of such a remote service system continues to cause a number of problems and concerns for both clients and service providers. The client needs to be configured with software and hardware to create a service request that is in a form that is readily transmitted or streamed over the particular communications network. The service request needs to be configured to satisfy communication and data transfer protocols implemented in the communications network. For example, the client may need to operate to convert its service request into a document for streaming, such as an extensible markup language (XML) document, and to create a string suited for the network protocol, such as Hypertext Transfer Protocol (HTTP), Hypertext Transfer Protocol Service (HTTPS), or User Datagram Protocol (UDP). The client further has to be equipped to open a communication connection with the service provider server and then transfer the service request over the communications network. Also, the returned response needs to be received and converted back to a useful form Each of these functions requires software code or applications to be created which involves initial costs to implement and troubleshoot and ongoing costs to maintain and revise.

Similarly, the service provider server needs to be adapted with software and hardware to receive the transmitted service request, transmit it to a target service, and return the response in proper form. Initially this may involve a security mechanism for insuring the request came from an accepted source and then converting the received data string to a useful document. Next, the converted document is transmitted to the target service for providing the service. The returned response is again handled and processed to create a string meeting communication protocols of the network and then transmitted over the network to the client. Again, each of these functions requires one or more software applications that have to be initially written, implemented on the service provider server, and maintained.

The problems with configuring a client and service provider server for receiving and providing remote services is further complicated as more and more services are added to the service provider server or to the distributed computer network. Presently, a service provider is forced to design each new service to provide each of these functions and particularly, the document conversion and communication connection functions. The new service is then implemented on the service provider server and the newly designed service must be adapted and errors corrected to ensure that data is properly converted to and from streaming documents and that desired communication connections are created and maintained during data transfers.

Hence, there remains a need for an improved method and system for efficiently providing and adding new services to a client-server system that facilitates streaming of service request and response data between client and service provider network devices over a communications network and for converting the streamed data into a form useful by the client and the service provider. Preferably such an improved method and system would be useful for automatically providing such functions and providing such functions in a manner that is transparent to the client and/or the service provider.

### SUMMARY OF THE INVENTION

Briefly stated, the present invention is useful in a client-server network model for addressing prior problems that arise when initially designing a service provider system and/or modifying the service provider system to add additional services. The present invention provides a service provider system that simplifies providing remote services to a client device by providing mechanisms and tools for automatically converting a service request object into a more network useful document, creating a communication connection with a target service provider device, and transferring the service request to the service provider device.

The present invention further provides mechanisms and tools for simplifying providing services that include receiving service requests over a network, converting the service request into a useful document and/or object, transferring the service request document to a target service, converting the resulting service response to a network ready form, creating a communication connection with the client device, and transferring the service response to the client device. These functions are provided in a relatively transparent manner that allows both clients and service providers to implement or call these functions with little or no modifications and with little or no knowledge of how, these functions are achieved by the mechanisms and tools of the present invention.

More particularly, a computer system is provided for automating the communications between client and service provider devices linked via a data communications network, such as the Internet, a LAN, or a WAN. The computer system includes a service provider server linked to the communications network configured to provide a target service or in communication with the target service. The service provider server includes a conversion and connection mechanism for receiving streamed service requests, for converting the streamed service request into a request document (such as an XML document or text document), and transmitting the request document to the target service. The service provider server may also include a tool for automatically converting the request document into a service request object expected as input by the target service.

The computer system further includes a client device linked to the communications network. The client device includes a client that functions to create a service request object that is converted by a request generator into a request document. The client device also includes a conversion and connection mechanism for receiving the request document and parsing the request document to identify the target service and service provider server servicing the target service. The conversion and connection mechanism then functions to open a connection (such as a socket connection) at a port of the service provider server. The mechanism prepares the request document for streaming over the communications network by converting it into a stream and applying protocols (e.g., any streaming protocol may be used, and more preferably, one based on TCP/IP). The mechanism then automatically transmits the converted request document to the service provider server.

The target service returns a response object, which is converted by a response generator at the service provider server into a response document (such as an XML document). The conversion and connection mechanism at the server acts to prepare the response document for streaming back to the client device by creating a string and applying transfer protocols. The protocols may be the same for all communications, such as HTTP, HTTPS, or UDP, or may be unique to the direction of the communication or to the particular receiving device or to a particular security implementation. The mechanism acts to automatically open a communication connection with the appropriate client device with a port on the client device being allocated by the base networking protocol and transmits the response string. The client device and the server can be thought of as using a single communication connection. The client device receives the streamed response string and uses its conversion and connection mechanism to create an instance of the response document (preferably having the same form, such as an XML document with the expected data types). The response document may further be converted to a response object or other form of data expected by the client by the request generator or other tool.

### BRIEF DESCRIPTION OF THE DRAWINGS

FIG. 1 illustrates a service provider system including the automated object to document conversion and communication connection mechanisms of the present invention;

FIG. 2 illustrates select components of the service provider system of FIG. 1 to better show data flow during operation of the service provider system;

FIG. 3 is a flow diagram showing exemplary operation of the service provider system of FIG. 1.

### DETAILED DESCRIPTION OF THE PREFERRED EMBODIMENTS

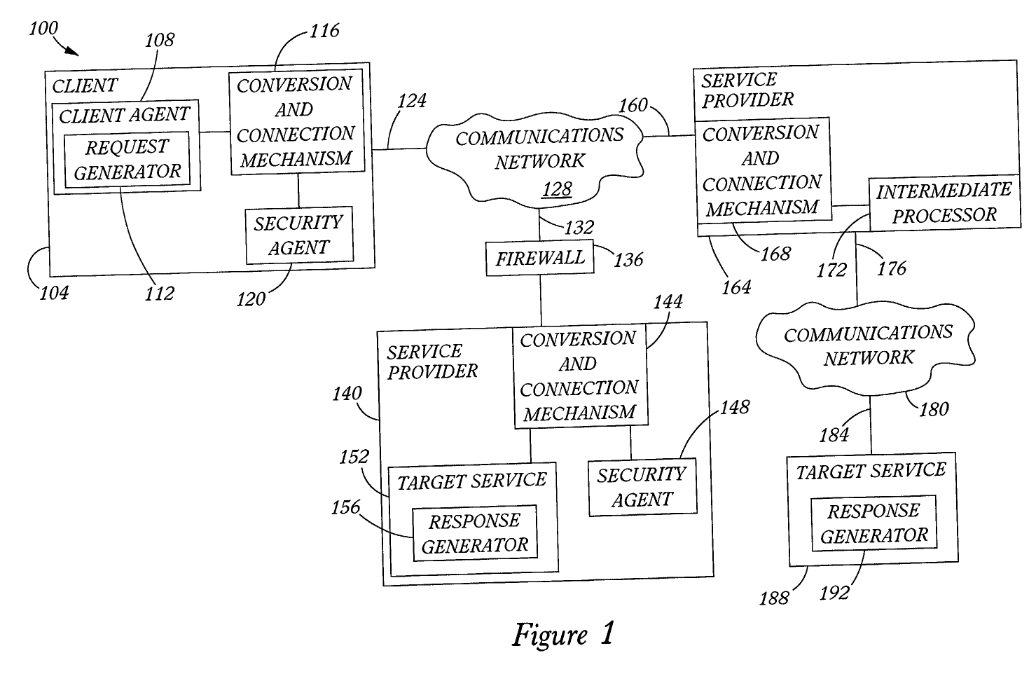

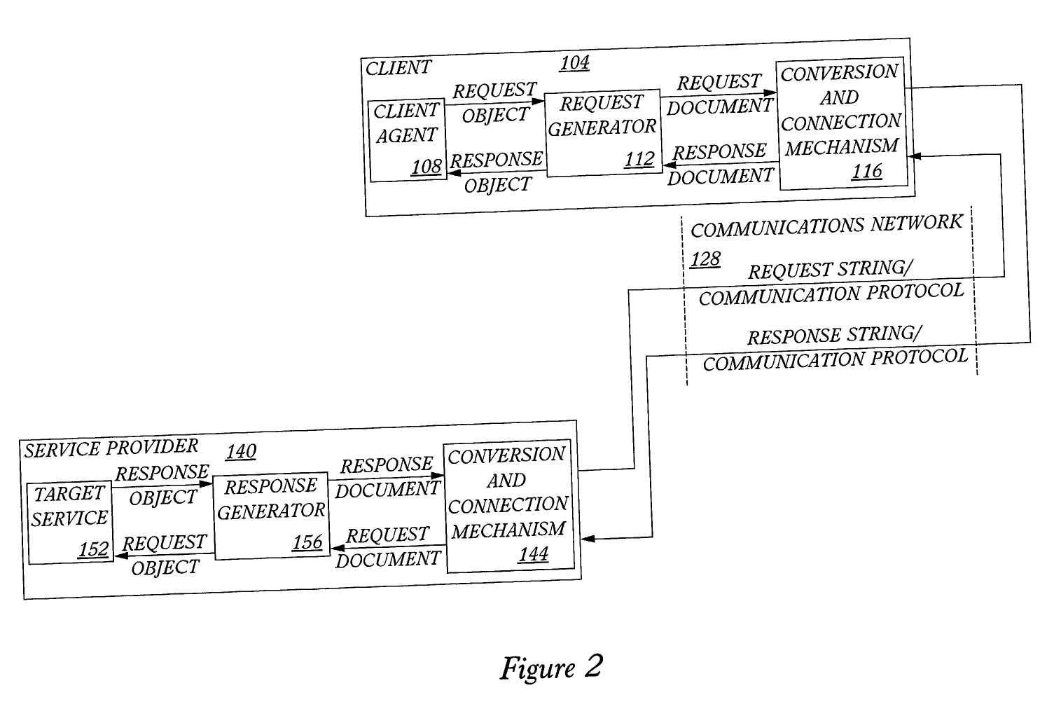

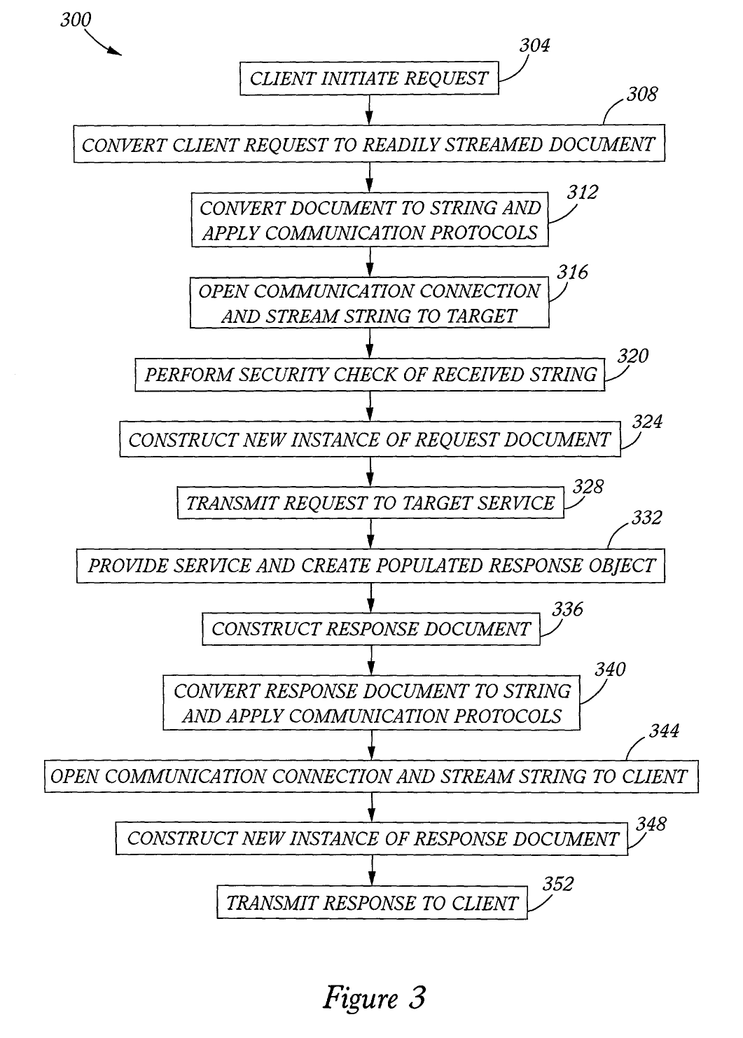

To provide a full understanding of the present invention, the invention is described generally as operating in a network environment of a service provider system 100, as shown in FIG. 1, that includes an exemplary client 104, a communications network 128, and service providers 140, 164. The description of the invention then proceeds to a more specific example of how data flow proceeds within the service provider system 100 during a typical service request and response operation, as shown in FIG. 2, and then to a discussion of the operation of the various components of the service provider system 100 with reference to FIG. 3. From the general description of the service provider system 100 and data flow, one skilled in the art will readily understand that the invention applies generally to the distribution of services within any distributed computing network. Hence, the present invention applies specifically to a client-server model and generally to all communications systems configured for providing remote services in a distributed computing model.

FIG. 1 illustrates one embodiment of a service provider system 100 useful for allowing remote service providers to communicate with and provide services to a plurality of client devices located throughout a computer network. The services provided may include, for example, credit card billing and authorization, other financial transactions, and other online services. The specific services provided by service providers 140, 164 is not as important as the features of the invention that allow the service and client to readily communicate over the communications network 128 and the enable additional services and service providers to be easily added to the service provider system 100.

As illustrated, the service provider system 100 includes a client 104 (although numerous clients are typically included in the system 100) and service providers 140, 164 that are in communication via the communications network 132 (e.g., the Internet, a LAN, a WAN, and the like) and communication links 124, 136, 160. In the following discussion, computer and network devices, such as client 104 and service providers 140, 164 are described in relation to their function rather than as being limited to particular electronic devices and computer architectures. To practice the invention, the computer devices and network devices may be any devices useful for providing the described functions, including well-known data processing and communication devices and systems such as personal computers with processing, memory, and input/output components and server devices configured to maintain and then transmit digital data over a communications network. The communication links 124, 136, 160 may be any suitable data communication link, wired or wireless, for transferring digital data between two electronic devices. Data is typically communicated in digital format following standard communication and transfer protocols, such as streaming protocols based on TCP/IP such as HTTP, HTTPS, UDP and the like, but this is not intended as a limitation of the invention.

The client 104 shown includes a client agent 108 that operates to initiate a service request and includes a request generator 112. The client agent 108 generally functions to create and populate a request object, such as during a credit card transaction, and the request generator 112 is included to convert the request object into a document that is useful for transmitting over the communications network 128. The client agent 108 and request generator 112 and other components providing the functions of system 100 may comprise software, hardware, and combinations thereof. For example, but not as a limitation, in one embodiment, the client 104 and service provider 164 are server devices configured for Java™ that utilize combinations of classes, packages, and methods to provide the described functions. Note, the software implementing these functions and particular instances of the software may be located at numerous locations in the system 100 to effectively provide the described functions and are not limited to the physical locations shown in FIG. 1.

The client 104 also includes a conversion and connection mechanism 116 that is adapted for receiving the request document from the client agent 108 and responding by establishing a communications link with a target service provider based on information in the service request document. The conversion and connection mechanism 116 converts the request document into a data string that satisfies the protocols of the communications network 128 and transmits the converted string over links 124, 132, 160 and communications network 128 to the targeted service provider 140 or 164. The conversion and connection mechanism 116 is further adapted to receive response strings from the service providers 140, 164 and to convert the string into a useful response document to pass to the client agent 108. A security agent 120 may be provided to validate that the response string and/or converted document is from a proper source and is well-formed (as will be explained below).

As illustrated, two service providers 140, 164 are included in the system 100 for responding to service requests from the client 104 by providing services (such as returning requested and/or modified information). Service provider 140 is linked to the communications network 128 by link 132 and is behind a firewall 136. The service provider 140 includes a conversion and connection mechanism 144 for receiving request strings from the client 104 and performing a security check with the security agent 148. The security check may simply be verifying that the string originated from an acceptable source (such as a client 104 that is allowed to access the services of the service provider 140) or may also include determining if a document formed from the string is well-formed (as will be explained with reference to FIG. 2).

The conversion and connection mechanism 144 acts to create an instance of the passed request document from the streamed string and to pass the document to the target service 152. The target service 152 provides the requested services and includes a response generator 156 for automatically converting the request document into an object or other form that is expected by the target service and for converting a response object created by the target service 152 into a response document. The response document, similar to the request document, takes a form useful for streaming on the communications network 128 and is passed to the conversion and connection mechanism 144. The conversion and connection mechanism 144 functions to convert the response document to a string with appropriate protocols and to transmit the response string to the client 104 for its use and further processing.

The second service provider 164 is shown in communication with the communications network 160 for receiving service request strings and includes a conversion and connection mechanism 168 for receiving the string and converting the string into a request document which is passed to an intermediate processor 172. The intermediate processor 172 can perform a number of functions such as validating the document for security and form (“well-formed”) or simply to route the request document to a proper target service. Target service 188 may receive the request document directly or over a communications network 180 and links 176, 184. The target service 188 includes a response generator 192 for placing the request document in an expected and useful form for the target service 188. The target service 188 creates a populated or completed response object which the response generator 192 configures as a response document and returns to the intermediate processor and conversion and connection mechanism 168 for transmittal to the client 104.

Referring now to FIG. 2, the data flow in the server provider system 100 is described to facilitate the functions provided in a transparent manner by the request and response generators 112, 156, 192 and the conversion and connection mechanisms 116, 144, 148. As illustrated, the client agent 108 typically populates and transmits a request signal or object indicating the type of data being sent and providing the information or data. For example, in a credit card transaction there may be levels or differing types of data that are sent and the request object would include both a type of data indication and the actual data for which a request is being made, e.g., credit card billing and/or authorization. The information will also include a target service 152 and/or service provider 146, such as by providing a target network address (e.g., an Internet address or URL).

The request generator 112 is included in the client agent 108 or is called by the client agent 108 to convert the request object to a document or file useful for transferring the request information in the object over the communications network 128. Numerous data forms and documents may be utilized in this regard including markup language documents, such as Hypertext Markup Language (HTML) or Standard Generalized Markup Language (SGML) documents. In a preferred embodiment, the request generator 112 is configured to automatically convert the request object to an eXtensible Markup Language (XML) document. XML documents have proven useful in the system 100 because it is a meta-markup language that does not have a fixed set of tags and elements (as does HTML) that lends itself to easy and independent formatting of data. The request generator 112 functions to tag data members and insert them into the XML document or request document. XML documents are text that can readily be read by any tool that can read a text file and are especially adapted for exchange of data over networks. XML further lends itself to security or validation procedures as request documents can be validated at the client 104 and the service provider 140, 164 against a document data definition (DTD) known by these devices or included within the request document.

The conversion and connection mechanism 116 receives the request document and prepares it for transmittal over the communications network 128 (as well as opening a communication connection at the service provider 140). This conversion process typically involves converting the request document, such as an XML document, to a data string that complies with appropriate communication and streaming data transfer protocols such as those based on TCP/IP such as HTTP, HTTPS, or UDP or some other protocol. In one preferred embodiment, the conversion and connection mechanism 116 is adapted to use HTTP to stream or transmit the request string over the communications network to the service provider 140.

The service provider 140 utilizes its conversion and connection mechanism 144 to receive the request string and into a request document. In one embodiment, the conversion and connection mechanism 144 functions to create a new instance of an XML document and set initial values in the document. The mechanism 144 may further verify the validity of the document, such as by verifying that the request document complies with the DTD (e.g., is it a well-formed document), and to verify security by checking the source of the document (e.g., is it a well-formed document from an expected and/or acceptable source). The response generator 156 converts the request document into a request object and transmits it to the target service 152 (or alternatively, passes the XML document directly to the target service 152). The target service 152 performs the requested service or otherwise determines an appropriate action and creates a response object.

The response generator 156 processes the response object and passes a response document, such as an XML document with response data tagged and inserted, to the conversion and connection mechanism 144. The mechanism 144 then acts to prepare the response document for streaming on the network 128 by creating a response string meeting a selected transfer protocol, such as HTTP, HTTPS, or UDP. The client 104 receives the response string and uses the conversion and connection mechanism 116 to create a response document having a useful form, such as an XML or a SGML document. The request generator 112 then automatically converts (or not, as applicable) the response document into a response object which is understandable to the client agent 108 that made the original request.

FIG. 3 illustrates exemplary functions of the service provider system 100 during the request and provision of a remote service. The process 300 begins with the installation or creating an instance of the components illustrated in and discussed with reference to FIG. 1. The process 300 then continues with the client 104 initiating a service request at 304, such as by creating an object indicating data types and including an identifier of a target service (such as a server identifier and network address). At 308, the client's request is converted to a document readily streamed over the communications network 128 (such as an XML or SGML document). This functionality may be provided by the request generator 112, by the conversion and connection mechanism 116, or by another tool (not shown) adapted for converting to and from such a document format (e.g., to and from XML or SGML). Significantly, this conversion is provided in a transparent manner such that the client agent 108 simply creates a service request indicating a target service provider.

At 312, the process 300 continues with the request document being converted to a data string with any useful streaming protocol for transfer over the communications network 128. In a preferred embodiment, this conversion is performed by the conversion and connection mechanism 116 which processes the request document to retrieve the target service to address the service request string. The protocol used to stream the string may be any useful streaming protocol and may include encoding and encrypting messages. For example, the transfer protocol may be selected to be any protocol based on TCP/IP such as HTTP, HTTPS, and UDP.

At 316, a communication connection is established with the appropriate service provider 140, 164 indicated in the service request document. A number of tools may be implemented to provide all or portions of this function. For example, a protocol handler may be built by the mechanism 116 for determining protocol and looking up a stream or string handler, an object for parsing the URL and creating a socket connection at an appropriate port of the service provider. The protocol handler of the mechanism 128 may include tools for encryption and decryption of the service request. The request string is then streamed to the open port, which is generally allocated by the base network protocol.

At 320, the service provider 140, 164 uses the conversion and connection mechanism 168 to perform a security check, such as with security agent 148, of the received service request string. The security check may include verifying the source of the string and validating of the document (e.g., is the request a well-formed XML document per a DTD). At 324, the process continues with the creation of a new instance of the request document, such as by initiating an XML or SGML document and setting initial values. The request document is transmitted at 328 to the target service 152, 188. The request document may first be converted to an object having the form expected by the target service 152, 188. At 332, the target service 152, 188 provides the requested service and returns a response object. At 336, a response document is constructed for streaming across the network 128, such as an XML or SGML document with the response information tagged and inserted within the document.

At 340, the conversion and connection mechanism 144, 168 acts to convert the response document to a string and to use communication protocols to ready the string for streaming. At 344, the mechanism 144 parses the string to determine an appropriate communication port and connection. A socket is established at the appropriate port on client 104 typically allocated by the base networking protocol and the response string is streamed to the client 104, such as via HTTP, HTTPS, or UDP. At 348, the conversion and connection mechanism 116 constructs a new instance of the response document and transmits it to the client agent 108 at 352 (prior to this transmittal the request generator may function to convert the request document from XML or other document form to an object or other form expected by the client agent 108).

The system 100 and process 300 can be readily implemented in Java™ or other object-oriented programming languages. In the client-server embodiment shown, the client agent 108 and mechanism 116 can be a standalone application and the service providers 140, 164 may be a servlet that resides on a server, such as a web server. In a preferred embodiment, the two communications between the client 104 and the service providers 140, 164 are both completed using XML to stream the data with each object (the request and the response) being converted to XML. These implementations can be adapted such that the client 104 can be coded with a call to the request generator 112 and the conversion and connection mechanism 116. New services can be quickly added to the system 100 because the service providers 140, 164 simply have to implement calls to conversion and connection mechanism 144, 168 and response generators 156, 192 but does not have to recreate these functions, thereby reducing initial designs and troubleshooting of implemented new services.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

For example, the conversion and connection mechanism 116 at the client may be configured for use with numerous network communication and transfer protocols. In one embodiment, the mechanism 116 is configured to parse the request document to determine the target provider 140, 164 (such as based on a URL), to determine which protocols are expected or required by that target provider 140, 164 (for example, one provider 140 may require the data be streamed using HTTP, that the document meet certain data form, and that a specific encryption methodology be used to pass the firewall 136 while a second provider 164 may not require specific encryption be used but require HTTPS be used for streaming). The mechanism 116 then functions to convert the request document from the client agent 108 to a string using the appropriate protocol. The determination of which protocols to use for each service provider 140, 164 may be determined at connection time or be retrieved from memory. In this manner, the client agent 108 does not need to know how to convert the request document for streaming or how to establish the communication connection but merely needs to pass a service request to the mechanism 116.

We claim:

1. A computer system for automating communications between client devices and service provider devices linked to a data communications network, comprising:
a service provider device linked to the communications network including a conversion and connection mechanism for receiving streamed service requests, for converting the streamed service request to a request document, and transmitting the request document to a target service; and
a client device linked to the communications network including a client agent that creates a service request and a conversion and connection mechanism that parses the service request to identify the target service, that opens a communication connection with the service provider device, and that transmits the streamed service request over the communications network to the service provider device.

2. The computer system of claim 1, wherein the conversion and connection mechanism of the service provider is further configured for receiving a response document, for in response opening a communication connection with the client device, for converting the request document to a request string, and for streaming the response string to the communication connection at the client device over the communications network.

3. The computer system of claim 2, wherein the response string is streamed using a streaming protocol based on TCP/IP.

4. The computer system of claim 3, wherein the streaming protocol is selected from the group consisting of HTTP, HTTPS, and UDP.

5. The computer system of claim 2, wherein the service provider includes a response generator adapted to create the response document from a service response created by the target service.

6. The computer system of claim 5, wherein the response document and the request document are in a formatted structure used by the service provider and the client device.

7. The computer system of claim 6, wherein the formatted structure is an extensible Markup Language (XML) document or a Standard Generalized Markup Language (SGML) document.

8. The computer system of claim 2, wherein the conversion and connection mechanism of the client device is adapted for converting streamed response string into an instance of the response document.

9. The computer system of claim 8, wherein the instance of the response document is in a formatted structure document and wherein the client device further includes a component for recognizing the formatted structure and converting the instance of the request document to a service response useable by the client agent.

10. A method for use in a service provider system for automating communication conversions and connections, comprising:
receiving, over a communications network from a client machine, a streamed service request for a target service; converting the streamed service request into a request document;
transmitting the request document to the target service;
in response, receiving a response document from the target service;
converting the response document to a service response configured for streaming over the communications network;
allocating a port on the client machine with a base networking protocol, wherein the client machine and the target service use a single connection; and
streaming the service response to the port of the client machine.

11. The method of claim 10, wherein the streamed service request converting includes verifying the client machine is an acceptable source of service requests and verifying validity of the request document by comparing included data types in the request document with expected data definitions.

12. The method of claim 10, wherein the request document and the response document are in a formatted structure common to the target service and the client machine.

13. The method of claim 10, wherein the response document converting and the service response streaming are performed according to a streaming protocol based on TCP/IP.

14. The method of claim 10, further including converting the request document into a request object prior to the transmitting and creating the response document from a response object received from the target service prior to the response document receiving.

15. A method for use in a service provider client-server network, comprising:
at a client device:
generating a service request document having a first form;
converting the service request document into a service string having a streaming form according to a data transfer protocol;
allocating a port on the client device based on a base networking protocol to establish a single communication connection with a service provider device identified in the service request document;
transmitting the service string over a communications network to the communication connection at the service provider device;
at the service provider device:
converting the service string into an instance of the service request document having the first form;
transmitting the instance to a target service;
receiving a response document based on the instance;
converting the response document into a response string having a streaming form according to the data transfer protocol;
allocating a port on the client device to establish the communication connection with the client device; and
transmitting the response string over the communications network to the port at the client device.

16. The method of claim 15, further including at the client device:
receiving the response string;
converting the response string into an instance of the response document; and
providing the instance of the response document to a client agent.

17. The method of claim 16, wherein the first form and a form of the response document are in formatted structure common to the client device and the service provider device.

18. The method of claim 15, wherein the data transfer document is streamed using a streaming protocol based on TCP/IP.

19. The method of claim 15, further including at the client device:
determining the data transfer protocol based on the service provider device identified in the service request.
